(19) United States
(12) Patent Application Publication
(10) Pub. No.: US 2026/0049590 A1
(43) Pub. Date: Feb. 19, 2026

(54) AIR-FILLED KAPLAN RUNNER

(71) Applicant: GE Renewable Technologies, Grenoble (FR)

(72) Inventors: Pierre-Yves LOWYS, BROSSARD (CA); Guy LABRECQUE, BROSSARD (CA); Pierre-Luc FOREST, BROSSARD (CA); Fernando-Henrique GAION, Taubate (BR)

(21) Appl. No.: 19/101,027

(22) PCT Filed: Aug. 3, 2023
(86) PCT No.: PCT/EP2023/071513

§ 371 Date: Feb. 4, 2025

(30) Foreign Application Priority Data
Aug. 4, 2022 (EP) 22306182.1

(51) Int. Cl. F03B 11/00; F03B 3/06

(52) U.S. Cl. CPC F03B 11/002; F03B 3/06; F05B 2260/64

(57) ABSTRACT

A water-fed turbine includes a shaft and a Kaplan runner having a plurality of blades and a hub, the hub located at an end of the shaft and bearing the blades. Means are provided for generating dry air, as well as a means for supplying the turbine with a flow of the dry air. Means are also provided for evacuating air out of the turbine after the flow of dry air has flowed at least through the hub.

### RELATED APPLICATIONS

The present application claims priority to PCT Application No. PCT/EP2023/071513, filed Aug. 3, 2023, which claims the benefit of European Patent Application No. 22306182.1, filed Aug. 4, 2022. Both applications are incorporated herein by reference in their entirety.

### TECHNICAL FIELD AND PRIOR ART

The invention concerns turbines equipped with Kaplan runners.

The general structure of a Kaplan turbine 100 is illustrated in FIG. 1. The turbine 100 includes a runner 112 that is secured at a first end of a rotating shaft 126 centered on a vertical axis Z1 and configured to rotate around said axis in operating conditions. It further comprises a hub 114 equipped with a series of movable or adjustable runner blades 116. Coupling flanges 118 connect each runner blade 116 to the hub 114, so that the blades are adjustable. The runner 112 is housed in the upper part of a draft tube 200 that is designed for evacuating water downstream and for increasing the efficiency of turbine 100. A volute 122 is arranged around the runner 112 and is fed with water. Indeed, the volute 122 is usually connected to a non-represented penstock that extends from a non-represented upstream reservoir. As a result, water outbursts in the volute 122 with a high potential energy. Water flows afterwards between the blades 116 of runner 112, thereby inducing the runner 112 to rotate. The flow rate of water circulating around the runner 112 is regulated by the blades themselves and also by means of guide vanes 124 that are disposed in a circular pattern within the distributor. The guide vanes 124 are each pivotable around an axis parallel to axis Z1 to reduce or increase the flow rate of water entering the turbine 100.

A generator rotor 132 is connected at a second end of the shaft 126, which is opposed to the first end thereof in the longitudinal direction of the shaft 126, that is along axis Z1. The rotor 132 is disposed coaxially within a stator 134 of a generator 130.

Another embodiment to which the invention also applies is shown in FIG. 2. The shaft is arranged horizontally and the turbine (or bulb turbine) includes components identical or similar to those of FIG. 1 and which bear the same reference numbers. The blades 116 are attached to the hub 114 and are part of the bulb unit 106. The installation of FIG. 2 further includes a concrete structure 140 that delimits a horizontal channel C1 of circulation of water. The bulb 106 is disposed within the channel C1 and is adapted to rotate around a horizontal rotation axis X6 under the action of a forced water flow F coming from a non-represented reservoir. The bulb 106 includes a bulb casing 180 that is supported within channel Cl by a bulb hanger 109 and stay vanes 111. The runner 112 is coupled to a non-represented generator which is disposed within the bulb casing 180 and which delivers an alternative voltage to a non-represented electricity power grid.

In this application, the expression “Kaplan turbine” will refer to a turbine provided with a Kaplan runner, whatever the direction of its shaft. Alternatively, it will be referred to as a turbine with a Kaplan runner.

The moving parts of such turbines are usually lubricated with grease or oil.

For this reason, most Kaplan runner hubs are designed to be filled with oil, but we see more and more environmental pressures requesting oil free runners.

Oil free runners are known in the art, for example from CA 2889026, and are designed with self-lubricated bushings operating in a hub filled with water instead of oil. But this design is plagued with limitations and problems. The life expectancy of self-lubricated bushings and the blade's mechanisms components of the runner hub in water are much shorter than bronze bushings in oil due to corrosion, even when stainless steel is used.

In water-filled solution, a corrosion inhibitor is sometimes used to prevent/limit the corrosion inside the runner, but due to environmental constraints this kind of chemical products is less and less accepted and for most self-lubricated bushings, the wear and friction are still negatively impacted by water.

An air-filled hub can be implemented instead of a water-filled hub, but this type of runner is known to provide a humid environment which is also unfavorable for the life of the runner and prone to heavy detrimental rusting effects.

This detrimental effect is even present if the air-filled hub is maintained at a positive pressure, due to condensation and to potential minor water leaks inside the hub.

An air-filled design without air exchange is made by several manufacturers, wherein the oil inside the runner is replaced by air and the blade bronze bushings are replaced by self-lubricated material. The air is not changed in operation and accumulating water is usually drained during maintenance. But all water leakages coming from the blade seals and other localization create an environment which is highly corrosive. After a while the runner may be running with some mixture of humid air and liquid water inside it. Even if the water is drained automatically or during rare periodic maintenance, the corrosive environment is still present because the humid atmosphere remains.

There is therefore a need for a new system and a new method to operate and/or to lubricate a Kapan turbine.

### SUMMARY OF THE INVENTION

The invention first relates to a turbine that includes a shaft, a runner, or a Kaplan runner, which includes a number of blades and a hub, located at the end of the shaft and supporting the blades. The turbine further includes:
means for generating dry air;
means for supplying the turbine with a flow of the dry air; and
means for evacuating a flow of air out of the turbine after the flow of dry air has flowed at least through the hub.

Dry air is air with a dew point low enough to ensure no condensation inside the hub and able to remove or absorb humidity from the hub.

Preferably, the dryer, or the means for generating dry air, should be able to generate dry air having a dew point lower than 0° C., for example at or around −5 ° C. or preferably at or around −10° C., or at around −20° C. or at around −40° C. The lower the dew point, the more moisture is extracted from the runner hub. Preferably the dew point is at least 10° C. lower than the water temperature.

The dryer (or the means for generating dry air) can be selected based on its dew point and air flow rate. A dew point at least 10° C. lower than the water temperature provides a good capacity for efficient moisture removal, assuming a complete hub air exchange in a reduced time, for example in no more than 60 minutes.

Thus, a hub of a turbine, preferably comprising a Kaplan turbine, can be swept with dry air, eliminating at least part of, and preferably all, the water and humidity present in the turbine.

The interior of the runner hub is maintained dry and without humidity or condensation, for example originating from any leak, by circulating dry air inside the runner hub. This dry air is capable of eliminating water entering the hub from water leaks and will prevent condensation which eliminates any potential corrosion issue and optimizes the expected life of the runner components.

A turbine according to an embodiment of the invention may include means, for example one or more sensor(s), to monitor or measure the humidity of the flow of air evacuated out of the turbine. Thus, an air outlet can allow the monitoring of the air condition inside the runner hub.

A turbine according to an embodiment of the invention may further include an outlet chamber or tank to collect at least part of the flow of air evacuated out of the turbine. The humidity of the air of the flow of air can be monitored by one or more sensor(s) in the chamber. The outlet chamber can, for example, at least partly surround the shaft.

In a turbine according to an embodiment of the invention:
the means for supplying the turbine with a flow of dry air may include at least an inlet duct inside the shaft; the inlet duct may have a first section at least partly located in the shaft and a second section having a plurality of distributing ducts, for example at least two ducts connected to the first section and extending from the first section laterally or at an angle with respect to the direction of the shaft; the distributing ducts can distribute dry air at locations that are offset from the vertical axis of the runner;
and/or the means for evacuating a flow of air out of the turbine after the flow of dry air has flowed at least through the hub may include a duct, or an outlet duct, rotating with, or located inside, the shaft;
and/or the means for evacuating a flow of air out of the turbine after the flow of dry air has flowed at least through the hub may include an outlet to evacuate the air into a water flow.

In a turbine according to an embodiment of the invention, the means for supplying the turbine with a flow of dry air may include means for varying the flow or the frequency of the flow of dry air; for example it may include means for regulating or controlling the flow and/or the frequency of the flow of dry air, for example on the basis of an ambient air humidity degree and/or of water temperature and/or rate of humidity of the flow of air evacuated out of the turbine.

The invention also concerns a shaft for a turbine, the shaft including:
at least a first duct inside the shaft for supplying the turbine with a flow of air;

at least a second duct fixed to, and/or rotating with, or located inside the shaft for evacuating a flow of air out of the turbine after a flow of dry air has flowed at least through part of the turbine, for example through the hub.

The invention also concerns a method for operating a turbine as described above or in this application.

The invention also concerns a method for operating a turbine, for example a Kaplan runner as described above and/or in this application, the method including:
injecting dry air into the turbine;
circulating the dry air through at least part of the turbine, for example the hub;
and evacuating a flow of air out of the turbine after the flow of dry air has flowed at least through the hub.

Dry air may be generated from atmospheric air.

The invention concerns in particular a method for operating a turbine that includes a shaft and a Kaplan runner having a number of blades and a hub located at the end of the shaft and bearing the blades, wherein the method includes:
generating a flow of dry air;
supplying the turbine with the flow of the dry air;
evacuating a flow of air out of the turbine after the flow of dry air has flowed at least through the hub.

The dry air should preferably have a dew point lower than 0° C., for example at or around −5° C. or preferably at or around −10° C., or at or around −20° C. or at or around −40° C. The lower the dew point, the more moisture can be extracted from the runner hub. Preferably, the dew point is at least 10° C. lower than the water temperature. This provides a good capacity for efficient moisture removal, assuming a complete hub air exchange in a reduced time, for example in no more than 60 minutes.

A humidity rate of the flow of air which is evacuated out of the turbine can be measured. The flow and/or the frequency of the flow of dry air may be continuous or variable and/or adjusted depending on the humidity rate; the dry air flow may be for example regulated or controlled, for example on the basis of an ambient air humidity degree and/or of water temperature and/or rate of humidity of the flow of air evacuated out of the turbine.

In an embodiment of a method according to the invention:
the flow of dry air can be supplied to the turbine through an inlet duct at least partly located in the shaft; for example dry air can be distributed at locations which are offset from the axis of the runner (thus can be achieved with an inlet duct having a first section at least partly located in the shaft and a second section having a plurality of distributing ducts, for example at least two ducts connected to the first section and extending from the first section laterally or at an angle with respect to the direction of the shaft);
and/or the flow of air being evacuated out of the turbine through a duct, or an outlet duct, rotating with, or at least partly located in or inside the shaft;
and/or the flow of air being evacuated through an outlet into a water flow.

In an embodiment of a method according to the invention, the hub of the turbine can be filled with dry air.

A turbine, or a turbine having a Kaplan runner, according to the invention or implemented in a method according to the invention, can be of the horizontal type or of the vertical type, or can be operated at any angle between horizontal and vertical.

### BRIEF DESCRIPTION OF THE DRAWINGS

FIG. 1 shows an example of a known vertical Kaplan turbine;

FIG. 2 shows an example of a known horizontal Kaplan turbine, also usually referred as a bulb turbine;

FIG. 3 shows a turbine according to the invention;

FIG. 4 shows a more detailed view of a horizontal turbine according to the invention;

FIGS. 5A and 5B show variants of a vertical turbine according to the invention;

FIG. 6 shows another embodiment of a vertical or horizontal runner with an air exhaust in water;

FIG. 7 shows a more detailed view of a shaft of a turbine according to the invention;

FIG. 8 shows a dry air generating and supply system for a turbine according to the invention; and

FIG. 9 shows an example of control system to control a turbine or a process according to the invention.

### DETAILED DESCRIPTION OF SPECIFIC EMBODIMENTS

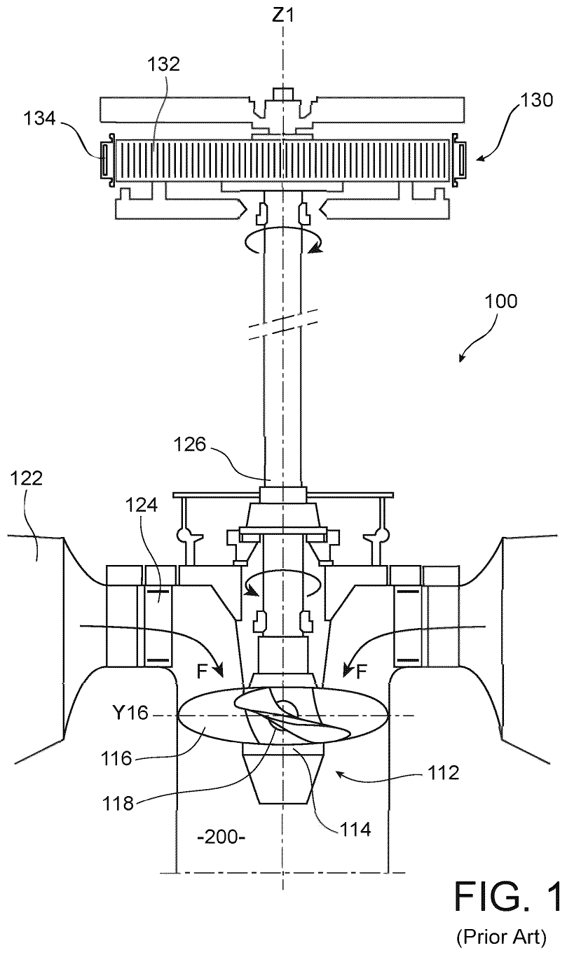

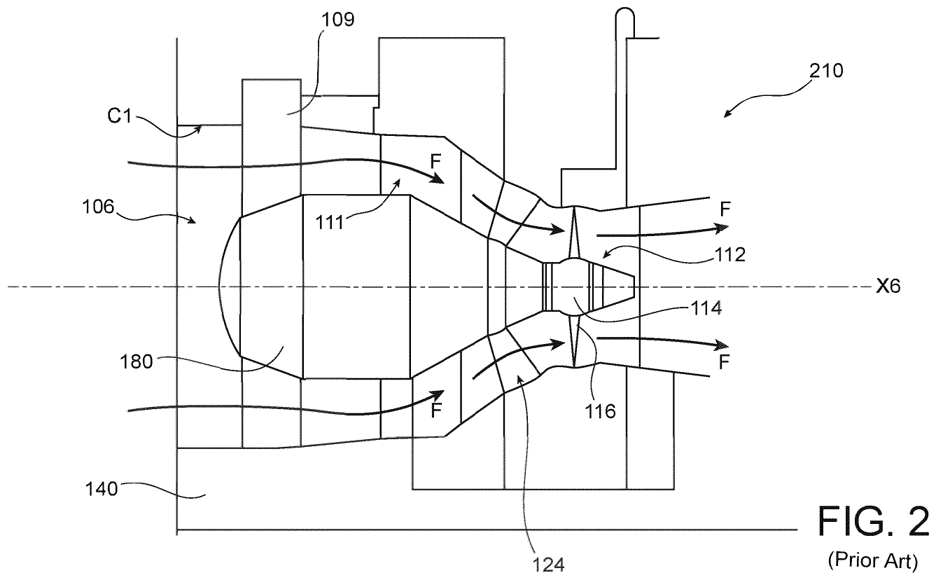

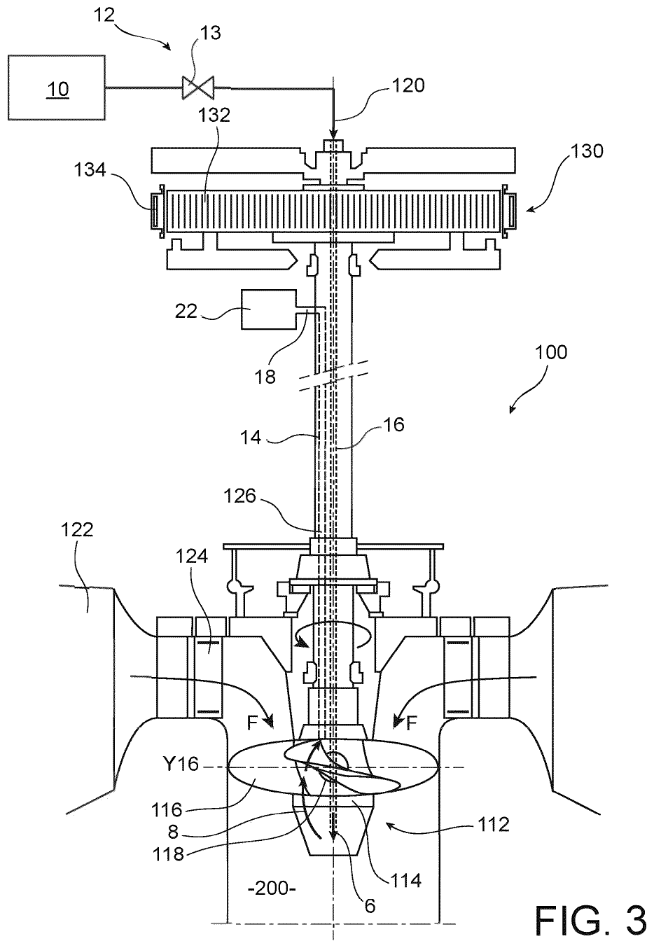

An example of a Kaplan turbine, or a turbine comprising a Kaplan runner, comprising a dry air supply system according to the invention is illustrated in FIG. 3, wherein the same reference numbers designate the same elements as discussed above in connection with FIGS. 1 and 2.

In this figure, a dry air generating system 10 is connected to a circuit 12 in order to inject a flow 120 of dry air into the turbine, for example into a duct 16 formed in the rotating shaft 126 and extending down to the hub 114, in particular in order to keep the interior of the runner hub dry.

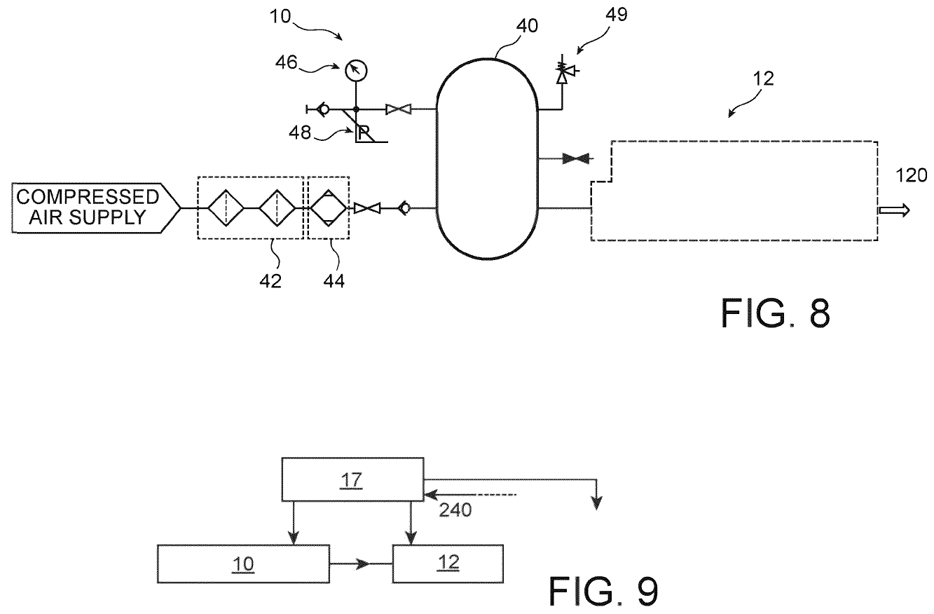

The system 10 generates dry air from atmospheric or outside air. Referring to FIG. 8, the system may include a tank or accumulator 40 (see FIG. 8) for buffering the dry air, a dryer 44, and a filter 42 and/or a compressor. This dry air may be compressed, for example at a pressure sufficient to provide the dry air flow. For a given pressure, the corresponding dry air flow can be calculated or obtained.

For example, for a Kaplan runner operating in water, for example water of a cold Nordic river, which has a temperature close to zero degree Celsius in winter, the upper limit for the dry air dew point should be zero degree Celsius. This would allow to avoid condensation inside the runner hub even when water is almost down to 0° C.

Furthermore, to remove moisture already present in the hub, the dry air should have a lower dew point than 0° C.: a dew point around −5 °C. or preferably −10° C., or −20° C. or −40° C. could be selected to allow some capacity to remove some moisture already present in the runner hub. The lower the dew point, the more moisture can be extracted from the runner hub.

A dryer (of the means for generating dry air) can be selected based on its dew point and air flow rate. The inventors have observed that a dew point at least 10° C. lower than the water temperature provides a good capacity for efficient moisture removal, assuming a complete hub air exchange in no more than 60 minutes. An example of dryer which can be implemented is a desiccant air dryer, for example a D2 modular desiccant dryer of Nano Purification Solutions, Inc, see for example www.n-psi. com, ref.17-100-0120, Issue 007, Series 2. The dryer can be a compressed air dryer using the pressure swing adsorption principle of drying compressed air, utilizing two identical columns each containing a hygroscopic desiccant bed. Other dryers can be used.

The humidity level or rate of this dry air can be measured to make sure condensation will not occur and/or to be able to drag some humidity from the runner hub, preferably even under the most adverse temperature conditions which is the coldest possible hub temperature when the runner is in operation, at rest or even during maintenance when runner can be exposed to ambient air temperature. In other words, this air has a dew point low enough to ensure no condensation is formed inside the hub and able to remove or absorb humidity from the hub.

The circuit 12 may comprise one or more regulating valve(s) 13 in order to regulate or to stop the flow 120 of dry air circulating in direction of the duct 16. The one or more valve(s) can be controlled by a control system of the unit, for example a computer or a processor (not represented in the figure), for example based on an information or a signal from a humidity sensor as explained below. An example of such a control system is illustrated in FIG. 9.

In particular, the flow 120 of dry air can be supplied to the Kaplan runner through the shaft 126, and more particularly through the duct 16 extending along the shaft. As illustrated in FIG. 3, the air 8 then circulates in the hub 114 where it is mixed with air already present therein and then evacuated through a return or evacuation duct 14 that may also be formed in the shaft 126 and flows outside the shaft through an air outlet 18. Alternatively, the return or evacuation duct 14 may be located outside the shaft; preferably it is against the shaft or fixed to the shaft, thereby rotating with it. An air outlet tank 22 may be connected to the air outlet 18 and may include means, for example a sensor, to monitor the air condition, in particular the humidity, inside the runner and particularly inside the hub 114. The flow 120 of dry air can be regulated based on information from the means or sensor about the humidity rate inside the hub.

A turbine of the Kaplan type is composed of different parts which are assembled together. Water can leak from the outside of the runner hub 114 into the runner hub in particular at the interfaces between the blades and their seals or where sealing flanges are present, at the runner cone for example. The flow of dry air which is circulated as explained above therefore becomes laden with humidity as it flows through the hub 114. The air at outlet 18 can therefore be moist air. Thus, the measurement of the humidity level or rate in the air at air outlet 18 is an indication of possible leaks in the turbine. This measurement of the humidity level or rate can be compared with a reference value or with the humidity level or rate of the flow 120 of dry air injected into the inlet duct 16. In other words, the air that flows through the runner can be tracked and/or analysed to check the humidity inside the runner and to detect the presence of any leakage. For example, as illustrated on FIG. 3, a chamber or tank 22 can be located at the outlet 18 and collect air which has flowed through the runner as explained above, such chamber or tank being provided with humidity sensor and/or a float (not represented on FIG. 3). It is also possible to exhaust the moist air directly into the river without circulating back to the chamber or tank 22. In this case, for example, a bluetooth sensor can be located in the runner cone. The above explanation, given in connection with a Kaplan turbine with a vertical shaft, also applies to a Kaplan turbine with a horizontal shaft or for a Kaplan turbine at any angle.

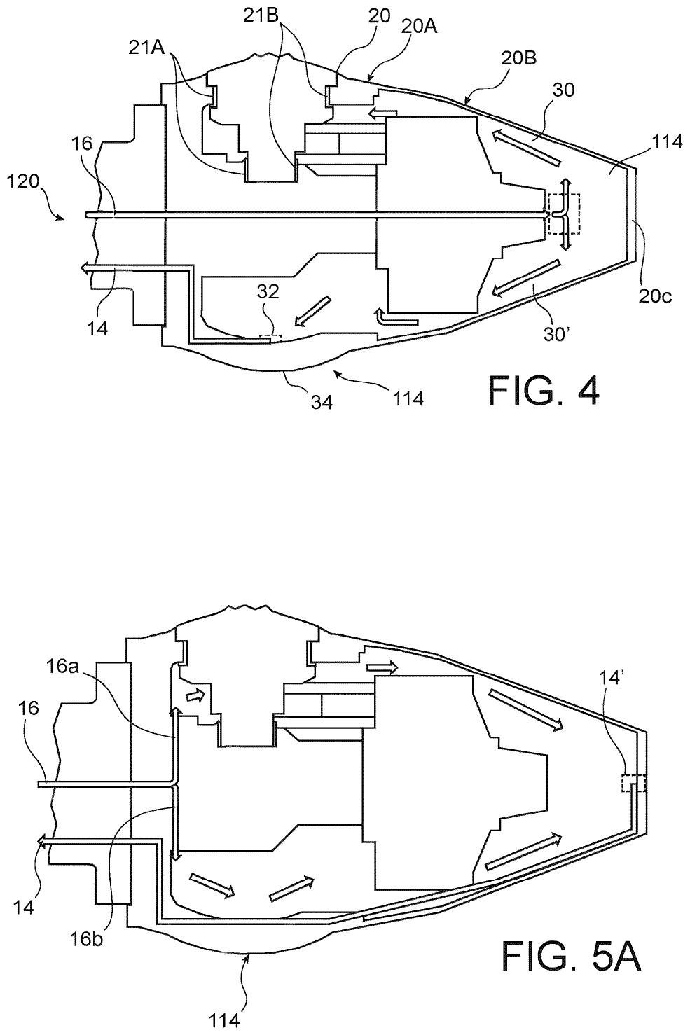

FIG. 4 is a more detailed example of a horizontal Kaplan turbine implementing the invention and showing details of the air flow in the hub 114. A flow of dry air 120 is injected into the runner through horizontal duct 16, then into the hub 114 and is swept through areas 30, 30′of the hub possibly containing water or humidity resulting from water leaking from outside the hub into the runner. References 20 (blade seals), 20A (cone flange), 20B (hub filling port), 20C (at cone closing plate) are examples of various locations where water can leak into the runner. Similar locations are found in a vertical Kaplan turbine. As it travels through the hub, the dry air can thus be progressively laden with humidity or moisture. It may flow through parts of the runner located at, or closer to, the zone 32 of largest diameter. References 21A and 21B designate bushings.

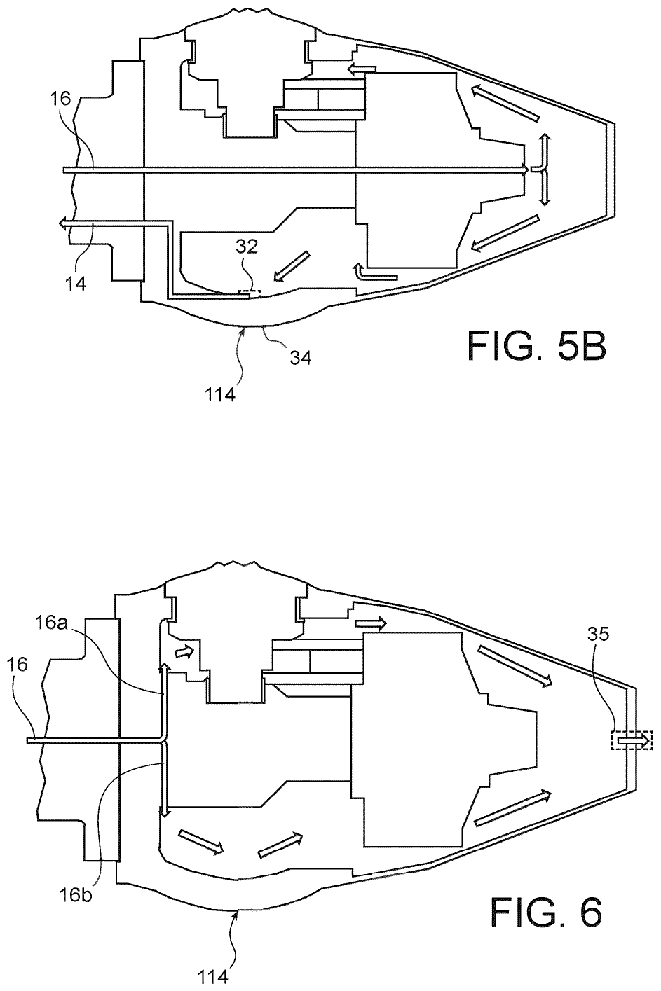

FIGS. 5A and 5B are other embodiments of a vertical Kaplan runner implementing the invention and showing details of the air flow through or into the hub 114. The same references as in FIG. 4 designate the same elements and reference is made for these elements to the above description. Here the dry air may flow through parts of the runner. The duct 14 is preferably positioned so that it may capture air at locations where water may accumulate during operation (FIG. 5B) and/or when the machine is stopped (FIG. 5A).

The inlet 14′to duct 14 (the drain) may be located at the bottom of the hub, as shown on FIG. 5A; this will depend on the operation of the machine and where the water should actually accumulate.

As shown on FIG. 5B, the inlet to duct 14 (the drain) may be located at the largest diameter of the runner, because when the machine rotates, water is going to flow to this area due to centrifugal forces.

In any of the embodiments given in this application, the inlet duct 16 may have a first section at least partly located in the shaft and a second section having a plurality of distributing ducts 16a, 16b (see for example on FIG. 5A), for example at least two ducts 16a,, 16b connected to the first section and extending from said first section laterally or at an angle with respect to the direction of the shaft. These distributing ducts 16a, 16b can distribute dry air at locations which are offset from the vertical axis of the runner.

FIG. 6 is a more detailed example of a vertical and/or horizontal Kaplan implementing the invention and showing details of the air flow through or into the hub 114 and the moisty air exhaust inside the water passage. The same references as in the preceding figures designate the same air inlet elements and reference is made for these elements to the above description. Here the dry air may flow through various parts of the runner. A moist air exhaust 35 can be positioned to exhaust the moist air directly to the water passage.

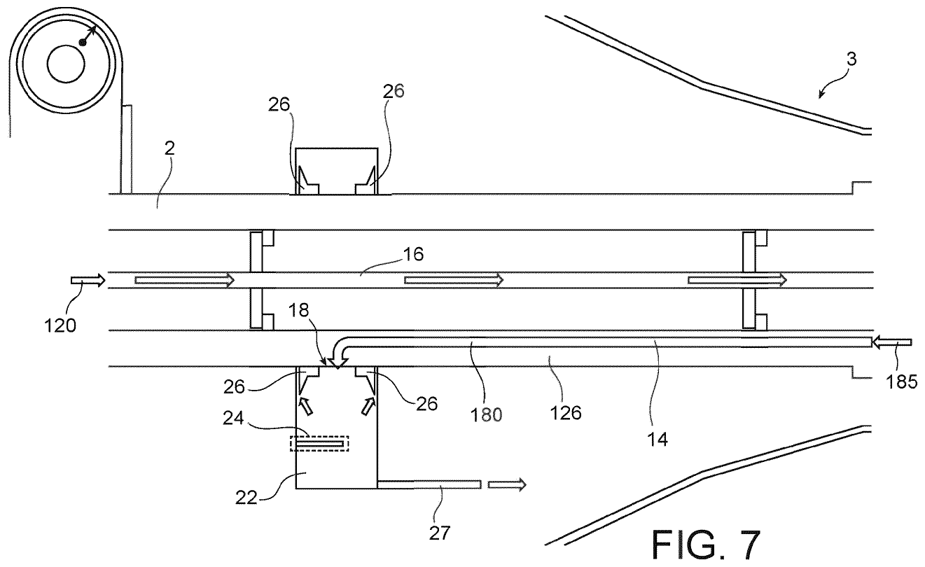

FIG. 7 shows a detail of the shaft 126 of an embodiment of the invention comprising both the inner duct 16 to introduce a flow 120 of dry air and the lateral duct 14 through which the moisture laden air 185 is evacuated. Air 185 can then be evacuated through the rotating outlet 18 and then possibly to a chamber or tank 22 which is fixed and located close to, or around, the shaft 126 with labyrinths 26 which can be fixed on the shaft in order to maintain a tight gap between the rotating parts (the shaft) and the static part (the tank 22, which is preferably fixed on static parts, and is for example centred around the shaft, without contact between the tank and the shaft). Thus the shaft, including the inlet and the outlet ducts 16, 14, is rotating while the exit tank 22 is preferably fixed with respect to the shaft, while being located close to or around it. The air can then be evacuated from the tank 22 through an outlet duct 27 to the atmosphere. The reference 24 designates at least one humidity sensor and/or a water level indicator (indicating a water level in the tank 22), which can provide information about the humidity and/or water level in the tank 22, thus giving a measurement of, or information about, the humidity level in the hub 114, and therefore an information about possible leaks of water from outside the turbine into the hub. The information about the degree or rate of humidity can be provided to a controller which can be programmed to regulate the volume and/or the frequency of the inlet air flow 120 and/or some maintenance plan based on the information. Alternatively, even without a controller, this information can be used to plan maintenance of the system, for example the replacement of one or more seal(s).

FIG. 8 shows an example of a dry air generating system 10 together with the air supply system 12 that can be implemented in the frame of the present invention. In this embodiment, one or more filter(s) 42, a dryer(s) 44 and a compressor feed a tank 40 with dry air. The pressure inside the tank 40 can be measured with a pressure gauge 46 and controlled by pressure sensor 48. The system may include a pressure limit or relief valve 49 to protect the tank. Dry air 120 can be supplied from the tank 40 to a Kaplan turbine through supply system 12 which for example comprises one or more valve(s).

An example of a control system for a system according to the invention is illustrated on FIG. 9. It comprises a processor or a computer 17 configured or programed so as to implement a process according to the invention, in particular in order:
to control the system 10 for generating dry air;
and/or to control the system 12;
and/or to receive signal(s) 240 from sensor(s), for example sensor(s) 24, and possibly regulate the volume and /r the frequency of the inlet air flow and/or some maintenance plan based on said signal(s);
and/or to control the turbine.

Alternatively, or in addition, the processor or computer 17 can be configured or programed so as to implement a process according to the invention, in particular in order to control:
the generation of a flow of dry air;
the supply of the turbine with said flow of said dry air;
the evacuation of a flow of air out of said turbine after said flow of dry air has flowed at least through the hub.

For example said processor or a computer 17 implements a computer program comprising instructions for implementing a method according to the invention.

The device of FIGS. 3-8 can be controlled by the processor or a computer 17.

The invention allows all elements of the runner, in particular the bushing(s) and/or bearing(s) and/or the blade mechanism to operate in dry air. The invention avoids any environmental risk associated with any liquid in the runner: there can be no leakage of any kind into the water of the river, since no oil or water inhibitor or anti-bacterial additive is used.

The invention also:
reduces friction and wear of most or all the internal elements and components of the hub, like self-lubricated bushing(s), which increases their life; all these components behave much better in air than in water, the invention therefore extends the life of these components and reduces the need to repair them or to repair the hub; eliminates risks associated with rust in the runner hub;
extends blades mechanical life to level comparable with what is usually seen for standard Kaplan runner with oil; indeed, as already explained above, the use of dry air reduces or eliminates the presence of humidity and therefore the risk of corrosion;
eliminates the galvanic corrosion risk related to water-filled Kaplan design and eliminates the impact of the water on the fatigue of the runner.

The dry air generated by the dry air generator can be used to fill the runner. As air is lighter than water, an air-filled runner improves the behaviour of the turbine regarding shaft line vibrations and critical speed and the turbine shaft fatigue life. The use of dry air ensures that the critical speed remains constant all the time: without dry air, some water can accumulate into the hub, which may results in a decrease in the critical speed after some time.

1. (canceled)

2-15. (canceled)

16. A water-fed turbine comprising:
a shaft;
a Kaplan runner comprising a plurality of blades and a hub, the hub located at an end of the shaft and bearing the blades;
means for generating dry air;
means for supplying the turbine with a flow of the dry air; and
means for evacuating air out of the turbine after the flow of dry air has flowed at least through the hub.

17. The water-fed turbine according to claim 16, further comprising means to monitor or measure humidity of the air evacuated out of the turbine.

18. The water-fed turbine according to claim 16, further comprising an outlet chamber or tank configured to collect at least part of the air evacuated out of the turbine.

19. The water-fed turbine according to claim 18, wherein the outlet chamber at least partly surrounds the shaft.

20. The water-fed turbine according to claim 16, wherein the supplying means comprises an inlet duct inside the shaft.

21. The water-fed turbine according to claim 16, wherein the evacuating means comprises an outlet duct that is fixed to, or rotating with, or located inside the shaft.

22. The water-fed turbine according to claim 16, wherein the evacuating means comprises an outlet configured to evacuate the air into a water flow.

23. The water-fed turbine according to claim 16, wherein the supply means comprises means for varying a flow or frequency of the flow of dry air.

24. The water-fed turbine according to claim 23, wherein the flow or frequency of the flow of dry air is regulated based on a humidity degree or flow rate of the of the air evacuated out of the turbine.

25. The water-fed turbine according to claim 16, wherein the supplying means comprises a tank configured to store the dry air.

26. The water-fed turbine according to claim 16, wherein the supplying means comprises an air dryer.

27. A method for operating the water-fed turbine according to claim 16, the method comprising:
generating the flow of dry air;
supplying the turbine with the flow of dry air; and
evacuating the air out of the turbine after the flow of dry air has flowed at least through the hub.

28. The method according to claim 27, further comprising measuring a humidity or a rate of flow of the air evacuated out of the turbine.

29. The method according to claim 28, further comprising varying the flow of dry air based on the humidity or rate of flow.

30. The method according to claim 27, wherein:
the flow of dry air is supplied to the turbine through an inlet duct that is at least partly located in the shaft; and
the air is evacuated out of the turbine through an outlet duct fixed to, or rotating with, or at least partly located in the shaft, or is evacuated through an outlet into a water flow.
